(19) United States
(12) Patent Application Publication
(10) Pub. No.: US 2017/0340096 A1
(43) Pub. Date: Nov. 30, 2017

(54) APPARATUS, SYSTEM AND METHOD FOR CARRYING TOOLS WITH A ROPE SEGMENT

(71) Applicant: Socket Snake, LLC, Dubuque, IA (US)

(72) Inventor: Thomas Edward Aronson, Dubuque, IA (US)

(73) Assignee: Socket Snake, LLC, Dubuque, IA (US)

(21) Appl. No.: 15/164,451

(22) Filed: May 25, 2016

(51) Int. Cl. A45F 5/02; B25H 3/00

(52) U.S. Cl. CPC A45F 5/021; B25H 3/003

(57) ABSTRACT

An apparatus, system and method has a rope segment defined by a length extending from a first end to a second end positioned opposite to the first end wherein the first end connects to the second end to form a loop. A first plurality of clips is interwoven with the rope segment. Each clip of the first plurality of clips extends from the rope segment at a fixed position along the length of the rope segment. A second plurality of clips interwoven with the rope segment. Each clip of the second plurality of clips extends from the rope segment at a fixed position opposite to the each clip of the first plurality of clips along the length of the rope segment. A socket is attached to each clip of the first plurality of clips and the second plurality of clips.

### BACKGROUND OF THE INVENTION

The present invention generally relates to an apparatus, system and method for carrying tools with a rope segment. More particularly, the invention relates to a socket retaining rope segment for retaining various parts and/or components associated with a socket wrench set.

Construction workers, carpenters, surveyors, plumbers, automotive technicians, electricians and/or other skilled laborers associated with, for example, the construction, manufacturing, engineering and/or renovation industries, often require access to tools to quickly and/or efficiently complete tasks. Accordingly, tool belts have been developed to provide such tradespeople access to tools while performing their intended task without otherwise interfering with the ability of the worker to complete the task.

More particularly, sockets, socket sets and/or socket wrenches are types of commonly used hand tools used by maintenance, facilities and/or construction personnel to attach and/or detach nuts and/or bolts. An appropriately sized socket must be used to receive and/or combine with a hexagonal head of a specific size. As a result, the worker must carry many sockets to have access to the various sizes that may be required for use on any given day and/or for any given project.

Maintenance and/or construction personnel require mobility and as a result may be relatively limited in the number and/or variations of sockets that may be carried on a tool belt at a worksite. To address shortcomings associated with traditional tool belts that may be used to carry a collection of sockets, certain tool belts provide interchangeable storage devices which may accommodate sockets of various shapes and/or sizes. For example, U.S. Pat. No. 5,893,498 to Aronson discloses a socket retaining mechanism to allow maintenance or construction personnel to access a socket. The invention provides socket retaining mechanisms, preferably adapted to be worn on an utility belt where several socket retaining mechanisms are strung from the utility belt. Similarly, U.S. Pat. No. 6,109,491 to Aronson discloses a socket retainer and utility belt to allow maintenance or construction personnel to access a socket.

Accordingly, known methods, apparatuses or systems for retaining sockets on a tool belt are known, but may not hold sockets securely at one or more fixed positions on the tool belt. Thus, a need exists for a socket retaining rope segment that may be attachable to a utility belt that may hold sockets in fixed positions.

### SUMMARY OF THE INVENTION

The present invention generally relates to an apparatus, a system and a method for carrying tools with a rope segment. More particularly, the invention relates to a socket retaining rope segment for retaining various parts and/or components associated with a socket wrench set.

The invention provides an apparatus having a rope segment defined by a length extending from a first end to a second end. The first end may have a protrusion and the second end may have a receptacle configured to receive the protrusion to attach the first end to the second end. A clip may be interwoven with the rope segment at a position on the rope segment. The clip may compress to accommodate insertion to the socket which may attach to a socket wrench.

Additionally, the invention provides a system that may have a sleeve formed as an integral piece from a textile. The sleeve may enclose a wrench across a length of the sleeve. Loops may extend across the sleeve in a direction generally transverse to the length. The loops may insert into the sleeve. Each loop may extend through the sleeve to insert into the clip.

Further, the invention provides a method for attaching a protrusion of a rope segment to a receptacle positioned opposite to the protrusion on the rope segment to form a loop. A clip may be threaded into the rope segment at a fixed position. A socket may be inserted onto the clip. The socket may be removed by a user of the rope segment to attach the socket to a wrench. The socket may be interchangeable with another socket of a different size on the rope segment. The clip may be compressed for insertion into the socket. The clip may expand to retain the socket. The loop may be inserted into the sleeve to hold the clip. A wrench may be slid into the sleeve.

Accordingly, it is an advantage of the present invention to provide an apparatus, a system and a method for carrying tools with a rope segment.

Another advantage of the present invention is to provide for a socket retainer that has a diameter ranging from one quarter of an inch to three-quarters of an inch.

Yet another advantage of the present invention is to provide a loop formed by the rope segment connecting with itself to slide and/or otherwise attach the loop to a utility belt.

Still another advantage of the present invention is to provide a sleeve formed as an integral piece from a textile where the sleeve encloses a wrench in the sleeve.

A further advantage of the present invention is to provide loops extending across the sleeve in a direction transverse to the length wherein the loops insert into through the sleeve.

Additional features and advantages of the present invention are described in, and will be apparent from, the detailed description of the presently preferred embodiments and from the drawings.

### BRIEF DESCRIPTION OF THE DRAWINGS

FIG. 1 illustrates a top view of a rope segment attached to socket retainers in accordance with an embodiment of the invention.

FIG. 2 illustrates a perspective view of a rope segment attached to socket retainers in accordance with an embodiment of the invention.

FIG. 3 illustrates a top view of a pair of rope segments in accordance with an embodiment of the invention.

FIG. 4 illustrates a top view of a pair of rope segments attached to each other in accordance with an embodiment of the invention.

FIG. 5 illustrates a top view of an utility strap with a sleeve in accordance with an embodiment of the invention.

FIG. 6 illustrates a top view of an utility strap with a sleeve in accordance with an embodiment of the invention.

FIG. 7 illustrates a perspective view of a an utility strap with a sleeve in accordance with an embodiment of the invention.

### DETAILED DESCRIPTION OF THE PRESENTLY PREFERRED EMBODIMENTS

In the following description, numerous details are set forth to provide an understanding of the present invention. Further, numerous variations or modifications from the described embodiments may be possible.

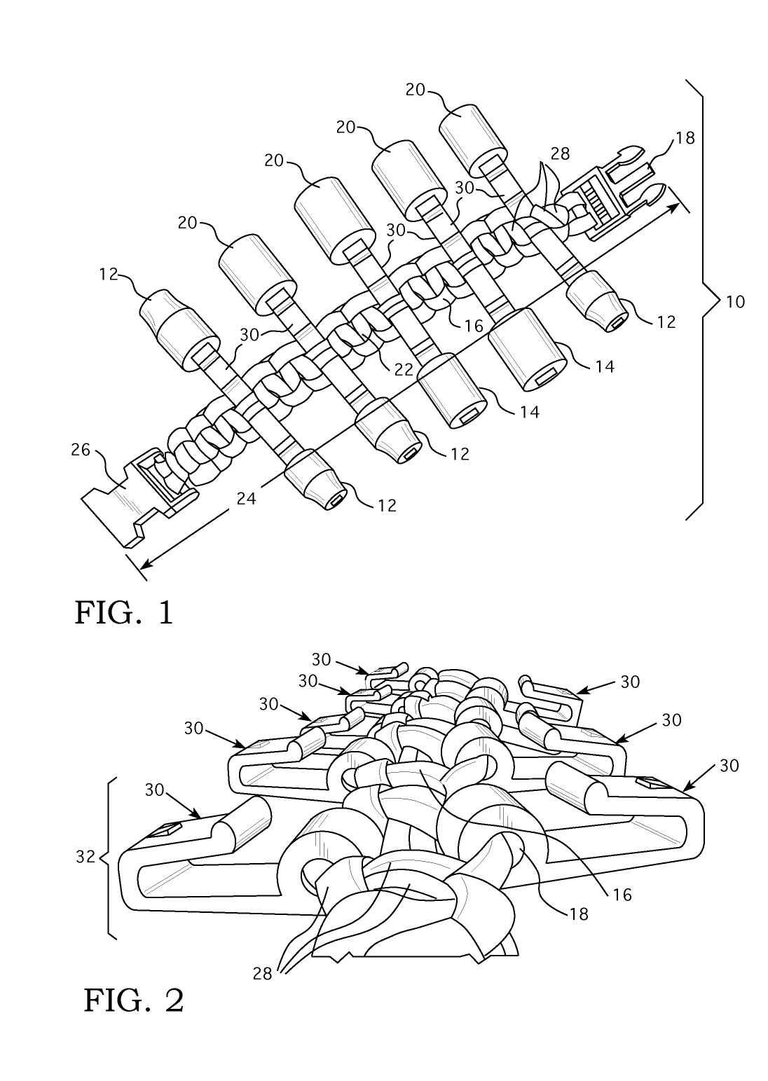

Referring to FIG. 1, a rope segment 10 is shown attached to one or more socket retainers and/or clips 30 which may extend from the rope segment 10. In an embodiment, fibers or cords 28 may be woven together to make the rope segment 10 as shown in FIGS. 1 and 2. The weaving and/or interconnection of the cords 28 may generally resemble a cord and/or a braid 16 that may be designed to provide the rope segment 10 with sufficient tensile strength to withstand heavy and/or repeated usage in a work environment, such as in construction and/or manufacturing industries.

The clip 30 may be attached to the braid 16 of the rope segment 10 by interweaving the cords 28 into a hole 18 on the clip 30. Accordingly, the clip 30 may be attached to and/or interwoven with the braid 16 of the rope segment 10 at a given position. The clip 30 may rotate perpendicularly relative to the length 24 of the rope segment 10. Further, interweaving the clip 30 with the cords 28 of the braid 16 may allow the clip 30 to remain at, for example, a substantially fixed position on the rope segment 10 along the length 24. Thus, a worker wearing a utility belt holding the rope segment 24 may remove a socket 20 from a given position on the rope segment 10.

Further, the rope segment 10 may have the length 24 that may accommodate clips 30 on each side of the rope segment 10. For example, as shown in FIG. 1, five of the clips 30 may be interwoven with the braid 16 of the rope segment 10 on each side of the rope segment 10. One of ordinary skill in the art may appreciate that a fewer or greater number of the clips 30 may be interwoven with the braid 16 to extend from either side of the rope segment 10. Further, FIG. 1 shows the clips 30 horizontally opposed to each other across the length 24 of the rope segment 10. The clips 30 may be interwoven with the braid 16 to be oriented at other positions on the rope segment 10 and/or angles relative to the length 24 of the rope segment 10.

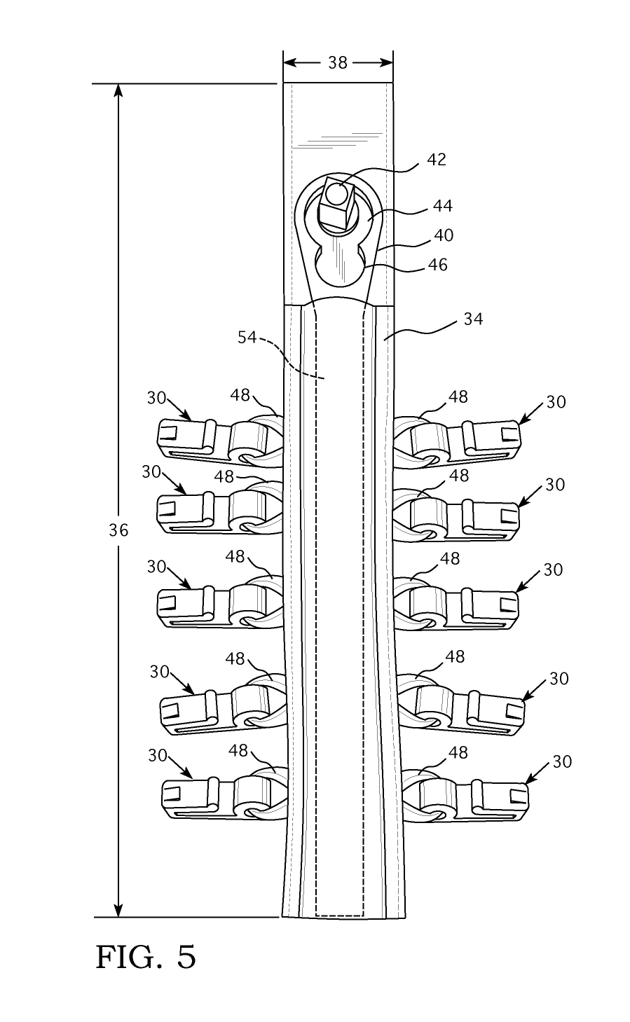

The clips 30 may be made from a substantially rigid material, such as metal, plastic and/or a composite, and compress and/or expand to accommodate insertion and/or attachment to corresponding socket 20. The socket 20 may be cylindrical in shape and may have a rectangular and/or square interior thread and/or threads designed to receive and/or to connect with the clip 30. More particularly, the clip 30 may be compressed to fit into the socket 20 and then expand upon release. The clip 30 may remain in a fixed and/or locked position with and/or inside the socket 20 that may be identifiable to a worker using the rope segment 10 by, for example, a “clicking” and/or a “snapping” noise. In an embodiment, a socket connector 12 may be attached to one or more of the clips 30 on the rope segment 10. The socket connector 12 may have a tapered profile suitable for connection with various tools, such as a ratchet-type socket wrench 44 as shown in FIG. 5, for example.

The rope segment 10 may connect to another rope segment 10 by, for example, wrapping the rope segment 10 to insert a protrusion 18 to a receptacle 26 that may be positioned opposite to the protrusion 18. One of ordinary skill in the art that other forms of buckles and/or fasteners may be used, such as hook-and-loop fasteners, to connect the rope segment 10 to, for example, another rope segment 10. The protrusion 18 and the receptacle 26 may extend from opposing ends of the rope segment 10. The rope segment 10 may be wrapped to form a loop around, for example, a heavy-duty belt around the waist of a craftsperson or contractor, such as an electrician and/or a carpenter, who may hang additional tools from the belt.

In an embodiment, the clips 30 that may extend from the rope segment 10 may insert and/or otherwise attach to the socket 20 of various diameters ranging from, for example, one quarter (¼″) of an inch to three-quarters (¾″) of an inch to accommodate corresponding sizes of, for example, the socket wrench 44 that connects with a socket 20.

Specifically, a ratchet used with the sockets 20 may be a tool with a handle that may be attached to a rotating mechanism which attaches to a socket. In an embodiment, the socket may fit onto, for example, a bolt and/or nut. Pulled or pushed in a given direction, the ratchet may either loosen or tighten the bolt or nut attached to the socket. Turned in the opposite direction, the ratchet may not turn the socket but allows the ratchet handle to be re-positioned for another turn while remaining attached to the bolt or nut. The repetitive action, which may be referred to as “ratcheting,” may allow the fastener to tighten or loosen in increments without otherwise disconnecting the tool from the fastener.

In an embodiment, the clip 30 may accommodate the socket 20 that may have a diameter of one quarter of an inch (¼″), three-eighths of an inch (⅜″) or half an inch (½″) to correspond with and/or attach to the socket wrench 44. Further, the clips 30 that may extend from the rope segment 10 may fit into one or more sizes of the socket 20, wherein a worker may attach various sizes of socket 20 to different clips 30 on the rope segment 10. Thus, a worker wearing and/or using the rope segment 10 may access the sockets 20 of various sizes to attach to, for example, the socket wrench 44.

Further, as shown in FIGS. 1-4, five of the clips 30 may extend from each side of the rope segment 10 for a total ten clips 30. One of ordinary skill in the art will appreciate that a fewer or a greater number of clips 30 may be interwoven with the braid 16 of the rope segment 10 between the receptacle 26 and the protrusion across a length 24 of the rope segment 10 as shown in FIG. 1. Moreover, the clips 30 may not necessarily be positioned in a horizontally opposed configuration as shown in, for example, FIG. 1. The clips 30 may be interwoven with the braid 16 of the rope segment 10 in various shapes, sizes and/or configurations.

Referring to FIG. 2, the cords 28 that may be interwoven to form the braid 16 on the rope segment 10 are shown. One of ordinary skill in the art will appreciate that various other suitable forms and/or configurations of the cords 28 may create the braid 16 on the rope segment 10. Further, in an embodiment, the cords 28 of the braid 16 may be threaded and/or otherwise woven through the hole 18 in the clip 30. Accordingly, the clip 30 may attach to the braid 16 of the rope segment 10. Further, the clip 30 may be removed from the braid 16 by retraction and/or removal of the cords 28 that may be threaded through the hole 18 of the clip 30. In an embodiment, the clip 30 may have a height 32 where the clip 30 may compress generally along the height 32 to, for example, fit into the socket 20. After insertion into what may be a correspondingly shaped rectangular thread on the socket 20, the clip 30 may expand to attach to the socket 20. The clip 30 may be compressed along the height 32 to remove and/or to retract the clip 30 from attachment to the socket 20.

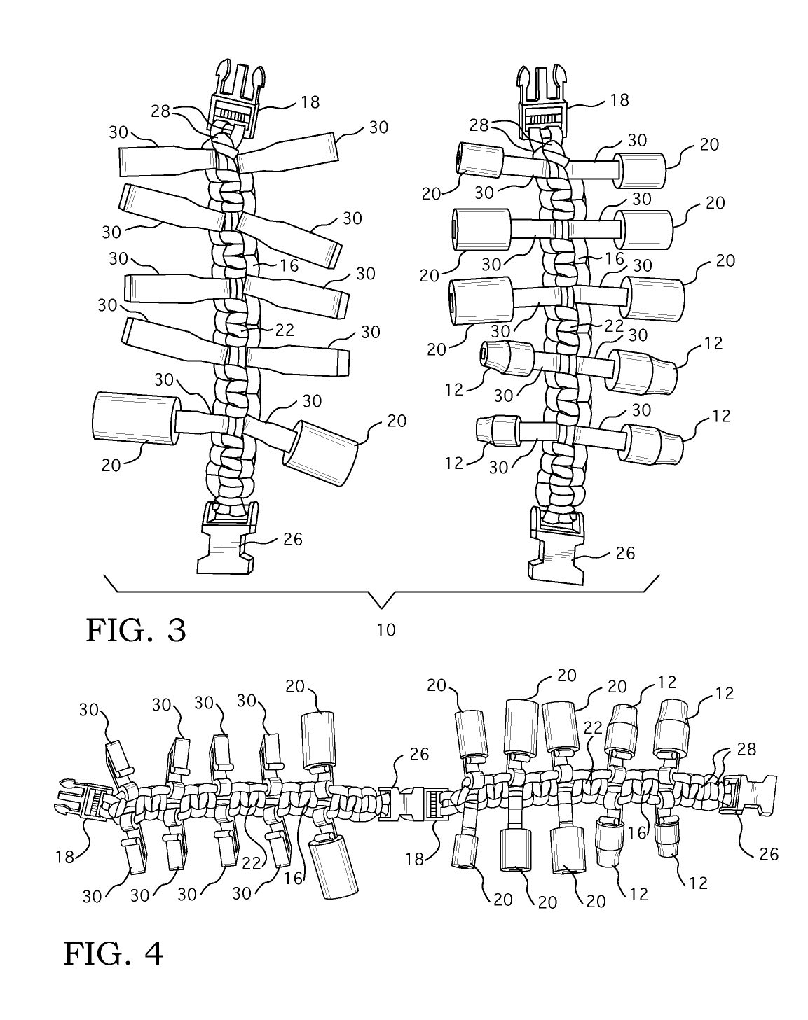

Referring to FIG. 3, several of the rope segments 10 are shown with various configurations of the sockets 20 and/or the socket connectors 12 that may be connected to various ones of the clips 30. The configuration, number and/or orientation of the socket 20 and/or the socket connectors 12 may be chosen by the wearer of the rope segment 10 to complete, for example, a specific job and/or task.

Referring to FIG. 4, the protrusion 18 of the rope segment 10 is shown attached to the receptacle 26 of another one of the rope segments 10. Accordingly, the rope segment 10 may be expanded by the sequential joining of one or more additional ones of the rope segments 10 to accommodate various additional ones of the socket 20 and/or the socket connectors 12 that may be required for a particular job and/or task.

Referring to FIG. 5, a sleeve 34 which may be formed as an integral and/or otherwise attached piece from a textile and/or other similar material is shown. The sleeve 34 may receive and/or enclose a body 54 of the socket wrench 44 that may extend across the length 36 of the sleeve 34. Several loops 48 may extend from the sleeve 34 in a direction generally transverse to the length 36. In an embodiment, the loops 48 may extend through the sleeve 34 behind the ratchet wrench 44 in the sleeve 34. Preferably, the loops 48 may not overlap with each other. Each of the loops 48 may extend through the sleeve 34 and insert into the clip 30. The loop 48 may be made from a substantially elastic material to stretch upon pulling away from the sleeve 34 as may be necessary to manipulate, attach and/or detach the clips 30, which may compress to fit into the socket 20 or the socket connector 12. The sleeve 34 may accommodate various configurations and/or orientations of the socket 20 or the socket connector 12 that may be attached to the clips 30.

The ratchet wrench 44 may have a protruding shaft 42 that may extend from a recession 46. The protruding shaft may insert into and/or combine with a correspondingly shaped nut and/or bolt. The ratchet wrench 44 may be inserted into the sleeve 34 to permit the protruding shaft to extend from the sleeve 34 as shown in FIG. 5, for example.

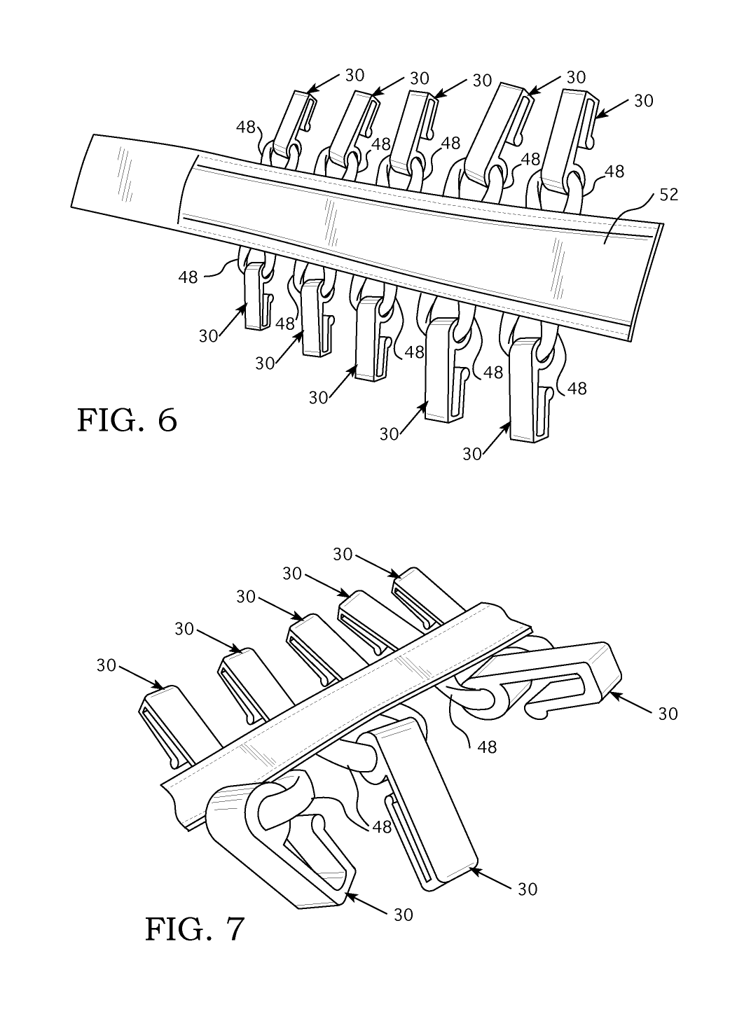

Referring to FIGS. 6 and 7, a reverse side 52 of the sleeve 34 is shown. In an embodiment, the loops 48 may be inserted through the sleeve 34 as shown in FIG. 6 as being substantially enclosed by the sleeve 34. FIG. 7 shows a detailed view of the loops 48 inserted through corresponding holes 18 on the clips 30 that may extend from the sleeve 34.

In an embodiment, a method for attaching the protrusion to the receptacle 26 to form a loop is disclosed. The clip 30 may be threaded into the rope segment 10. The socket 20 may be inserted onto the clip 30. The socket wrench 44, as shown in FIG. 5, for example, may be slid into the sleeve 34. In an embodiment, the socket wrench 44 may be removed from the sleeve 34. The socket 20 may be replaced with another socket 20 of a different size. The clip 30 may be compressed for insertion into the socket 20. The clip 30 may expand to attach to the socket 20. The loop 48 may be extended into the sleeve 34 to hold the clips 30.

Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

1. An apparatus comprising:
a rope segment defined by a length extending from a first end to a second end positioned opposite to the first end wherein the first end connects to the second end to form a loop;
a first plurality of clips interwoven with the rope segment wherein each clip of the first plurality of clips extends from the rope segment at a fixed position along the length of the rope segment; and
a second plurality of clips interwoven with the rope segment wherein each clip of the second plurality of clips extends from the rope segment at a fixed position opposite to the each clip of the first plurality of clips along the length of the rope segment.

2. The apparatus of claim 1 further comprising:
a cord woven with another cord to form the rope segment.

3. The apparatus of claim 1 further comprising:
a hole in the clip wherein the rope segment is interwoven with the hole in the clip.

4. The apparatus of claim 1 further comprising:
a socket attached to each clip of the first plurality of clips and the second plurality of clips.

5. The apparatus of claim 1 wherein the clip compresses to fit into the socket retainer.

6. The apparatus of claim 1 wherein the rope segment attaches to another rope segment.

7. The apparatus of claim 1 wherein the socket retainer has a diameter ranging from one quarter of an inch to three-quarters of an inch.

8. A system comprising:
a sleeve formed as an integral piece from a textile wherein the sleeve encloses a wrench in the sleeve;
a plurality of loops extending across the sleeve in a direction generally transverse to the sleeve wherein the plurality of loops extend through the sleeve; and
a clip wherein each one of the plurality of loops extends through the sleeve to insert into the clip and further wherein the clip compresses to attach to a socket wherein the socket is used with the wrench.

9. The system of claim 8 further comprising:
a body of the wrench enclosed by the sleeve.

10. The system of claim 8 wherein the loop is made from an elastic material.

11. The system of claim 8 wherein the plurality of loops is five.

12. The system of claim 8 wherein each loop of the plurality of loops is positioned opposite from another loop on each side of the sleeve.

13. The system of claim 8 further comprising:
a shaft extending from the wrench wherein the shaft inserts into a nut.

14. The system of claim 8 wherein ten loops extend from the sleeve.

15. A method comprising:
interweaving a plurality of clips into a rope segment wherein each clip attaches to the rope segment opposite another clip;
attaching a first end of the rope segment to a second end of the rope segment to form a loop; and
attaching a socket to the clip.

16. The method of claim 15 wherein the rope segment is formed from cords woven together.

17. The method of claim 15 wherein each clip rotates on the rope segment relative to a length of the rope segment.

18. The method of claim 15 further comprising:
removing the socket from the clip.

19. The method of claim 15 wherein each clip is stationary along a length of the rope segment.

20. The method of claim 15 wherein the first end of the rope segment is attached to the second end of the rope segment by a buckle.
